(19) United States
(12) Patent Application Publication
(10) Pub. No.: US 2026/0244566 A1
(43) Pub. Date: Aug. 20, 2026

(54) DATA RETENTION STATISTICS OF A MEMORY SYSTEM BASED ON REAL TIME CLOCK INFORMATION

(71) Applicant: Micron Technology, Inc., Boise, ID (US)

(72) Inventors: Zoltan Szubbocsev, Unterschleissheim (DE); Zheng Wang, Louisville, CO (US)

(21) Appl. No.: 19/540,354

(22) Filed: Feb. 13, 2026

Related U.S. Application Data
(60) Provisional application No. 63/760,504, filed on Feb. 19, 2025.

(51) Int. Cl. G06F 12/02

(52) U.S. Cl. CPC G06F 12/0246; G06F 2212/7201

(57) ABSTRACT

Methods, systems, and devices for data retention statistics of a memory system based on real time clock information are described. A memory system may be configured to implement data retention statistics based on real time clock information received from a host system. As part of implementation, the memory system may include hardware configured to receive the real time clock information, store data at a first time that is associated with the real time clock information, and store an indication associated with a duration that the data was stored at the memory system at a second time at which the data is invalidated. The memory system may then provide the indication to the host system.

### CROSS REFERENCE

The present Application for Patent claims priority to U.S. Patent Application No. 63/760,504 by Szubbocsev et al., entitled “DATA RETENTION STATISTICS OF A MEMORY SYSTEM BASED ON REAL TIME CLOCK INFORMATION,” filed February 19, 2025, which is assigned to the assignee hereof, and which is expressly incorporated by reference in its entirety herein.

### TECHNICAL FIELD

The following relates to one or more systems for memory, including data retention statistics of a memory system based on real time clock information.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not-or (NOR) and not-and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states when disconnected from an external power source.

### BRIEF DESCRIPTION OF THE DRAWINGS

FIG. 1 shows an example of a system that supports data retention statistics of a memory system based on real time clock information in accordance with examples as disclosed herein.

FIG. 2 shows an example of a data collection table that supports data retention statistics of a memory system based on real time clock information in accordance with examples as disclosed herein.

FIG. 3 shows an example of a data collection table that supports data retention statistics of a memory system based on real time clock information in accordance with examples as disclosed herein.

FIG. 4 shows an example of a flow diagram that supports data retention statistics of a memory system based on real time clock information in accordance with examples as disclosed herein.

FIG. 5 shows an example of a transaction diagram that supports data retention statistics of a memory system based on real time clock information in accordance with examples as disclosed herein.

FIG. 6 shows a block diagram of a memory system that supports data retention statistics of a memory system based on real time clock information in accordance with examples as disclosed herein.

FIG. 7 shows a block diagram of a host system that supports data retention statistics of a memory system based on real time clock information in accordance with examples as disclosed herein.

FIGS. 8 and 9 show flowcharts illustrating a method or methods that support data retention statistics of a memory system based on real time clock information in accordance with examples as disclosed herein.

### DETAILED DESCRIPTION

In some cases, data stored in a memory system for an extended time periods may induce stresses in the memory system and lead to a decrease in performance of the memory system. For example, the stresses may increase leakage in the memory system and cause reading errors and/or data loss in the memory system. Further, stresses and data loss may be more problematic in certain deployments. For example, non-volatile memory systems in vehicles may be subject to more extreme environmental conditions and may have relatively long data retention times.

Furthermore, failure to understand a usage model of the memory system that reflects the extended time periods may inhibit an ability to trim (e.g., tune) operational parameters that may increase the performance of the memory system. For a memory system including NAND memory devices, such operational parameters may include parameters related to programming times (e.g., t_{prog}), cross temperature capabilities (e.g., program/erase voltage temperature coefficient), and/or endurance (e.g., charge pump settings), among other examples.

In accordance with examples as described herein, a memory system may be configured to implement data retention statistics based on real time clock (RTC) information. As part of implementation, the memory system may include hardware configured to receive the RTC information, store data at a first time that is associated with the RTC information (e.g., recording RTC information at the time of writing the data), and store an indication associated with a duration that the data was stored at the memory system at a second time at which the data is invalidated, where the duration is associated with the RTC information. The memory system may then provide the indication to external resources, thereby enabling the statistically use and/or evaluation of the indication to trim operational parameters that improve the performance of the memory system and/or another similar memory system.

In addition to applicability in memory systems as described herein, techniques for data retention statistics of a memory system based on RTC information may be generally implemented to support increased connectivity of electronic systems. As the use of systems relying on interconnected electronic devices increases, such as electronic devices in the automotive industry that use NAND-based universal flash storage (UFS) devices or electronic devices in the computing industry that use NAND-based solid state drive (SSD) devices, the connectivity of these electronic devices becomes an increasingly relevant factor for the operations of the system. For example, delays associated with signals communicated between devices may become increasingly relevant as critical systems come to rely more on connectivity, as a system uses larger quantities of interconnected devices, or if the quantity and the complexity of signals communicated between devices increases. Implementing the techniques described herein may support techniques for increased connectivity in the electronic systems by increasing a read/write speed of data to and from the electronic systems, reducing power consumed by the electronic systems, and increasing the reliability of the electronic systems, among other benefits.

Features of the disclosure are illustrated and described in the context of systems, devices, and circuits. Features of the disclosure are further illustrated and described in the context of data retention tables, signaling transaction diagrams, and flowcharts.

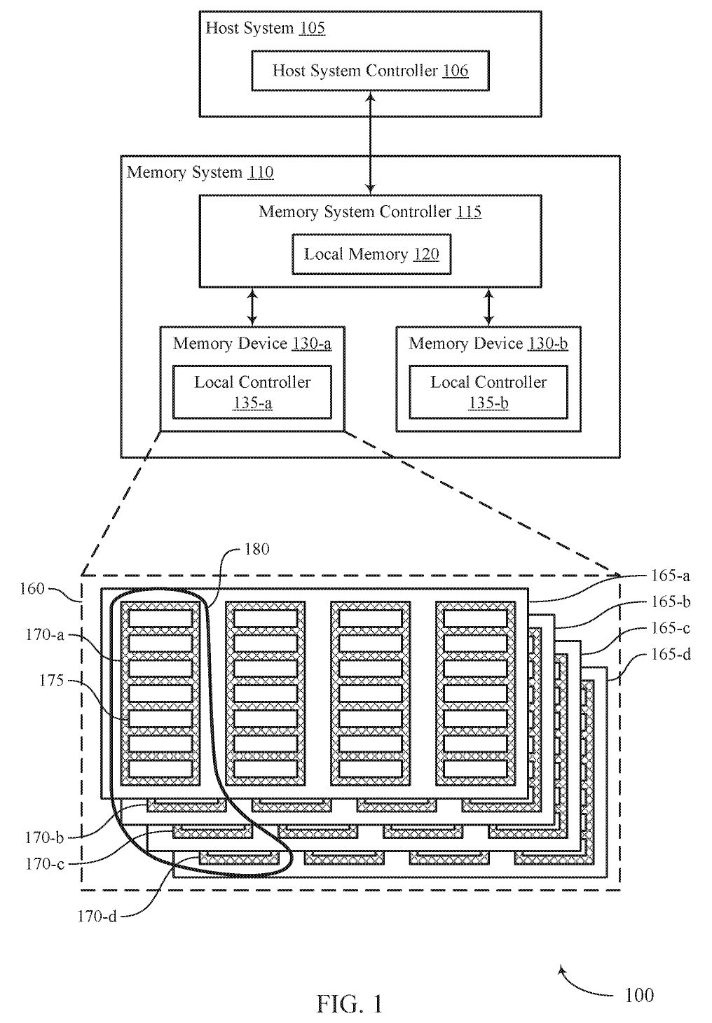

FIG. 1 shows an example of a system 100 that supports data retention statistics of a memory system based on RTC information in accordance with examples as disclosed herein. The system 100 includes a host system 105 coupled with a memory system 110. The system 100 may be included in a computing device such as a desktop computer, a laptop computer, a network server, a mobile device, a vehicle, an Internet of Things (IoT) enabled device, an embedded computer (e.g., one included in a vehicle, industrial equipment, or a networked commercial device), or any other computing device that includes memory and a processing device.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other devices.

The system 100 may include a host system 105, which may be coupled with the memory system 110. In some examples, this coupling may include an interface with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may, in some cases, be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a PCIe interface, a USB interface, a Fiber Channel interface, a Small Computer System Interface (SCSI), a Serial Attached SCSI (SAS), a Double Data Rate (DDR) interface, a DIMM interface (e.g., DIMM socket interface that supports DDR), an Open NAND Flash Interface (ONFI), and a Low Power Double Data Rate (LPDDR) interface. In some examples, one or more such interfaces may be included in or otherwise supported between a host system controller 106 of the host system 105 and a memory system controller 115 of the memory system 110. In some examples, the host system 105 may be coupled with the memory system 110 (e.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include a memory system controller 115 and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130—among other such operations—which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical block addresses (PBAs)) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include static random access memory (SRAM) or other memory that may be used by the memory system controller 115 for internal storage or calculations, for example, related to the functions ascribed herein to the memory system controller 115. Additionally, or alternatively, the local memory 120 may serve as a cache for the memory system controller 115. For example, data may be stored in the local memory 120 if read from or written to a memory device 130, and the data may be available within the local memory 120 for subsequent retrieval for or manipulation (e.g., updating) by the host system 105 (e.g., with reduced latency relative to a memory device 130) in accordance with a cache policy.

Although the example of the memory system 110 in FIG. 1 has been illustrated as including the memory system controller 115, in some cases, a memory system 110 may not include a memory system controller 115. For example, the memory system 110 may additionally, or alternatively, rely on an external controller (e.g., implemented by the host system 105) or one or more local controllers 135, which may be internal to memory devices 130, respectively, to perform the functions ascribed herein to the memory system controller 115. In general, one or more functions ascribed herein to the memory system controller 115 may, in some cases, be performed instead by the host system 105, a local controller 135, or any combination thereof. In some cases, a memory device 130 that is managed at least in part by a memory system controller 115 may be referred to as a managed memory device. An example of a managed memory device is a managed NAND (MNAND) device.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof. Additionally, or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on the same die, within the same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b. A local controller 135 may be or include a microcontroller, special purpose logic circuitry (e.g., a field programmable gate array (FPGA), an application specific integrated circuit (ASIC), a digital signal processor (DSP)), or any other suitable processor or processing circuitry.

In some cases, a memory device 130 may be or include a NAND device (e.g., NAND flash device). A memory device 130 may be or include a die 160 (e.g., a memory die). For example, in some cases, a memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as single level cells (SLCs). Additionally, or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, planes 165 may refer to groups of blocks 170 and, in some cases, concurrent operations may be performed on different planes 165. For example, concurrent operations may be performed on memory cells within different blocks 170 so long as the different blocks 170 are in different planes 165. In some cases, an individual block 170 may be referred to as a physical block, and a virtual block 180 may refer to a group of blocks 170 within which concurrent operations may occur. For example, concurrent operations may be performed on blocks 170-a, 170-b, 170-c, and 170-d that are within planes 165-a, 165-b, 165-c, and 165-d, respectively, and blocks 170-a, 170-b,170-c, and 170-d may be collectively referred to as a virtual block 180. In some cases, a virtual block may include blocks 170 from different memory devices 130 (e.g., including blocks in one or more planes of memory device 130-a and memory device 130-b). In some cases, the blocks 170 within a virtual block may have the same block address within their respective planes 165 (e.g., block 170-a may be “block 0” of plane 165-a, block 170-b may be “block 0” of plane 165-b, and so on). In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in the same page 175 may share (e.g., be coupled with) a common word line, and memory cells in the same string may share (e.g., be coupled with) a common digit line (which may alternatively be referred to as a bit line).

For some NAND architectures, memory cells may be read and programmed (e.g., written) at a first level of granularity (e.g., at a page level of granularity, or portion thereof) but may be erased at a second level of granularity (e.g., at a block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be erased before they can be re-written with new data. Thus, for example, a used page 175 may, in some cases, not be updated until the entire block 170 that includes the page 175 has been erased.

In some cases, to update some data within a block 170 while retaining other data within the block 170, the memory device 130 may copy the data to be retained to a new block 170 and write the updated data to one or more remaining pages of the new block 170. The memory device 130 (e.g., the local controller 135) or the memory system controller 115 may mark or otherwise designate the data that remains in the old block 170 as invalid or obsolete and may update a logical-to-physical (L2P) mapping table to associate the logical address (e.g., LBA) for the data with the new, valid block 170 rather than the old, invalid block 170. In some cases, such copying and remapping may be performed instead of erasing and rewriting the entire old block 170 due to latency or wearout considerations, for example. In some cases, one or more copies of an L2P mapping table may be stored within the memory cells of the memory device 130 (e.g., within one or more blocks 170 or planes 165) for use (e.g., reference and updating) by the local controller 135 or memory system controller 115.

In some cases, L2P mapping tables may be maintained, and data may be marked as valid or invalid at the page level of granularity, and a page 175 may contain valid data, invalid data, or no data. Invalid data may be data that is outdated, which may be due to a more recent or updated version of the data being stored in a different page 175 of the memory device 130. Invalid data may have been previously programmed to the invalid page 175 but may no longer be associated with a valid logical address, such as a logical address referenced by the host system 105. Valid data may be the most recent version of such data being stored on the memory device 130. A page 175 that includes no data may be a page 175 that has never been written to or that has been erased.

In some cases, a memory system controller 115 or a local controller 135 may perform operations (e.g., as part of one or more media management algorithms) for a memory device 130, such as wear leveling, background refresh, garbage collection, scrub, block scans, health monitoring, or others, or any combination thereof. For example, within a memory device 130, a block 170 may have some pages 175 containing valid data and some pages 175 containing invalid data. To avoid waiting for all of the pages 175 in the block 170 to have invalid data in order to erase and reuse the block 170, an algorithm referred to as “garbage collection” may be invoked to allow the block 170 to be erased and released as a free block for subsequent write operations. Garbage collection may refer to a set of media management operations that include, for example, selecting a block 170 that contains valid and invalid data, selecting pages 175 in the block that contain valid data, copying the valid data from the selected pages 175 to new locations (e.g., free pages 175 in another block 170), marking the data in the previously selected pages 175 as invalid, and erasing the selected block 170. As a result, the quantity of blocks 170 that have been erased may be increased such that more blocks 170 are available to store subsequent data (e.g., data subsequently received from the host system 105).

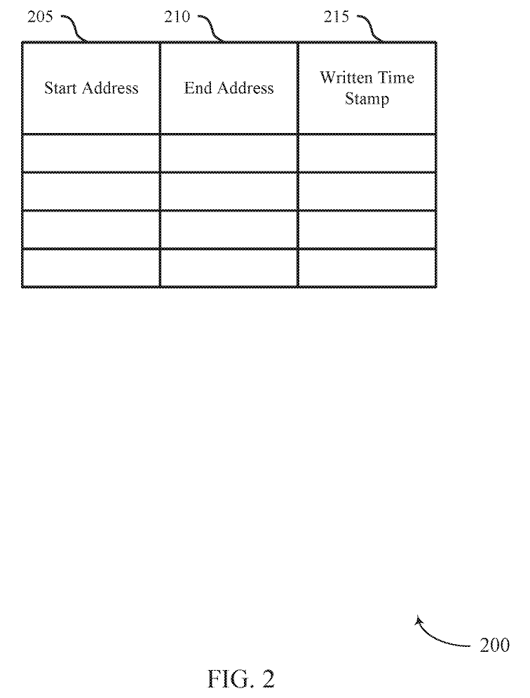

In some examples, and as described in greater detail in connection with FIGS. 2 through 9, the system 100 may perform one or more operations related to data retention statistics of a memory system based on RTC information provided by the host system 105 to the memory system 110. In some examples, the RTC information may be provided to the memory system and used as part of internal maintenance operations performed by a memory device 130.

The RTC information may include timestamp information (e.g., qTimestamp) that provides a mechanism for the memory system to 110 to tag events related to storing (and/or invalidating data) data by the memory system 110. The events, along with the timestamp information, may be stored as entries in a data collection table (e.g., an L2P mapping table) and/or registers of a memory device 130. The entries may be subsequently associated with one or more indications related to a duration that the data was stored at the memory system 110.

FIG. 2 shows an example of a data collection table 200 that supports data retention statistics of a memory system based on RTC information in accordance with examples as disclosed herein. The data collection table 200 may be a portion of an L2P mapping table or included in a register of a memory system (e.g., the memory system 100 and/or the memory device 130 of FIG. 1), among other examples. Furthermore, the data collection table 200 may store raw data that is related to data retention by the memory system.

As shown in FIG. 2, the data collection table 200 may include multiple rows that each accommodate an entry for a start address 205, an end address 210, and a written time stamp 215. Each row may be indicative of, and/or be associated with, data retention for data stored by (e.g., written to) the memory system. The data collection table 200 may be an example of a way to record RTC information at a time that data is written in the memory system. The RTC information stored at the time of writing the data may then be used to determine data retention statistics at a later time (e.g., in response to that same data being invalidated).

The start address 205 (e.g., an LBA or a PBA) and the end address 210 (e.g., an LBA or a PBA) may specify a range of memory locations for the data. Said another way, the start address 205 and the end address 210 may correspond to a size of a write command from a host system (e.g., the host system 105 and/or the host system controller 106 of FIG. 1) to the memory system.

The written time stamp 215 may specify a time at which the data was stored. In some examples, the memory system may determine the written time stamp 215 for (and/or associate the written time stamp 215 to) the data (e.g., the start address 205 and the end address 210) using RTC information provided by the host system to the memory system.

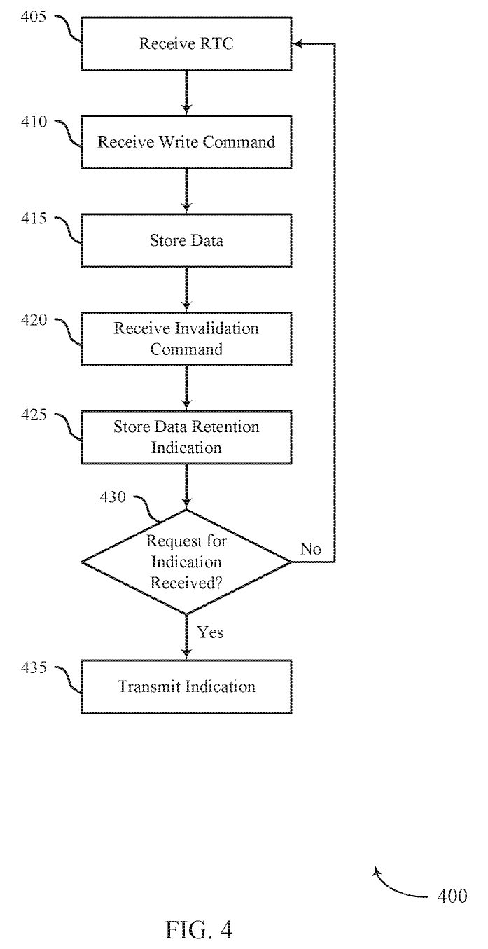

As described in greater detail in connection with FIGS. 4, 5, 8, and 9, the memory system may perform one or more operations that include receiving the RTC information and storing the data in the memory system at a first time (e.g., at the time the data is written) that is based, at least in part, on the RTC information. As part of storing the data, the memory system may populate the data collection table 200 with one or more entries (e.g., a start address 205, an end address 210, and/or a written time stamp 215 corresponding to the first time).

In some examples, the data collection table 200 may have a different structure than the structure shown in FIG. 2. As a first example, the data collection table 200 may include a starting address, a length of sequential data written, and a written time stamp. In a second example, the data collection table 200 may include either a start address or an end address (e.g., not both)) and a written time stamp. The addresses stored in the data collection table 200 may be physical address and/or logical addresses (in some examples).

The memory system may further store, at second time at which the data is invalidated, an indication associated with a duration that the data was stored. The indication may be based, at least in part, on the memory system using one or more entries of the data collection table 200 in combination with the second time. For example, and as part of storing the indication, a controller of the memory system (e.g., the memory system controller 115 and/or the local controller 135 of FIG. 1) may determine (e.g., compute) a difference between the first time and the second time (e.g., the duration that the data was stored) and store the difference as an entry in another data collection table.

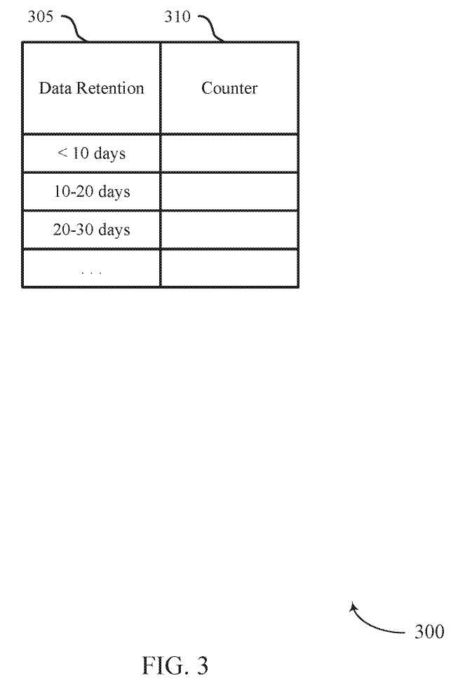

FIG. 3 shows an example of a data collection table 300 that supports data retention statistics of a memory system based on RTC information in accordance with examples as disclosed herein. The data collection table 300 may be included in a register of a memory system (e.g., the memory system 100 and/or the memory device 130 of FIG. 1), among other examples. The data collection table 300 may store statistics and/or analytics related to data retention by the memory system.

As shown in FIG. 3, the data collection table 300 may include multiples rows that each accommodate an entry associated with a data retention bin 305 (e.g., a time interval bin) and a counter 310. In some examples, the entry may correspond to an indication associated with a duration that data was stored by the memory system.

In some examples, a granularity of the data retention bin 305 may be variable. For example, and as shown in FIG. 3, the granularity of the data retention bin 305 is reflected in 10 day increments, which may be sufficient for determining a stress condition and/or a corresponding trim adjustment for certain applications. However, in other examples for other applications, the granularity of the data retention bin 305 may be in hourly increments, daily increments, weekly increments, monthly increments, or other suitable increments that are derivable using the RTC information. In some cases, the increments may be varying lengths. For example, there may be more frequent bins of counters for shorter data retention durations and less frequent bins of counters for longer data retention durations. An example of such a situation may be having a first bin for data stored less than 1 day, a second bin for data stored between 1–3 days, a third bin for data stored 3–7 days, a fourth bin for data stored between 7–15 days, a fifth bin for data stored between 15–25 days, a sixth bin for data stored between 25–35 days, and so forth.

In some examples, a controller of a system (e.g., the host system controller 106, the memory system controller 115, and/or the local controller 135 of FIG. 1) may perform one or more operations that determine and/or store the entry. For example, using an entry from another data collection table (e.g., the data collection table 200 of FIG. 2), the controller may categorize the difference between a first time (e.g., time data is written) and a second time (e.g., time data is invalidated) into a time interval bin corresponding to the data retention bin 305 and increment the counter 310.

In combination, the data retention bin 305 and the counter 310 are examples of statistics and/or analytics that may be determined by the controller and stored in the data collection table 300. In some examples, the data collection table 300 and/or the controller may be configured to support determining and storing other statistics and/or analytics. Other statistics and/or analytics may include distributions related to data retention by the memory system, standard deviations related to data retention by the memory system, ranges related to data retention by the memory system, correlations between data retention and operating conditions of the memory system, and/or correlations between data retention and trim settings of the memory system, among other examples.

FIG. 4 shows an example of a flow diagram 400 that supports data retention statistics of a memory system based on RTC information in accordance with examples as disclosed herein. The flow diagram 400 is performed by a memory system and includes signaling transactions between a host system and a memory system. In some examples, the memory system of FIG. 4 may include one or more UFS devices. Additionally, or alternatively, and in some examples, signaling transactions between the host system and the memory system may use a UFS electrical interface.

At 405, RTC information is received by the memory system, which may be transmitted by the host system. In some examples, the host system may continuously transmit the RTC information to the memory system. In some examples, the host system may periodically transmit the RTC information to the memory system.

At 410, a write command may be transmitted (e.g., by the host system) to the memory system, which is received by the memory system. The write command may include data that is to be stored by the memory system.

At 415, the data may be stored by the memory system. The memory system may further store one or more entries in a data collection table (e.g., the data collection table 200 of FIG. 2), including a time at which the data was received and/or stored by the memory system based on the RTC information.

At 420, an invalidation command may be identified for data stored at the memory system (e.g., by the memory system). The invalidation command may come from a variety of sources. In some examples, the host system may transmit an invalidation command to the memory system (e.g., a command causes the memory system 110 to invalidate the data). In some examples, the invalidation command may originate from a garbage collection operation, a refresh operation, a write operation, a purge operation, an unmap operation, an erase operation, or another operation that invalidates the data.

At 425, a data retention indication may be stored (e.g., by a memory system). The indication may be based, at least in part, on the time at which the memory system wrote the data in the memory system (e.g., a first time) and a time at which the memory system invalidated the data (e.g., a second time). The indication may be determined and/or stored in a data collection table (e.g., the data collection table 200 of FIG. 2 and/or the data collection table 300 of FIG. 3), may include a raw data entry, a statistics entry, and/or an analytics entry as described in connection with FIG. 2 and/or FIG. 3. As examples, the indication may include one or more of a beginning storage address of the data, an ending storage address of the data, a time at which the data was initially stored, a time at which the invalidation command was received by the memory system 110, a duration that the data was stored, a count for a time interval bin associated with the duration, and/or another suitable entry stored in the data collection table.

At 430, it may be determined whether a request for the indication is received (e.g., transmitted by the host system and received by the memory system). In some examples, the request may specify a particular indication and/or combination of indications. If an indication is received, the flow proceeds to 435. If the indication is not received, then the other parts of the flow may occur and information may continue to be stored.

At 435, the indication may be transmitted (e.g., by the memory system to the host system).

In some examples, the information (and/or the indication) may be received and/or stored by a host system that is a server. The server may be an enterprise server used for high-speed data logging at a research and development center that supports design and development of the memory system. Alternatively, the server may be an embedded server that is integrated into an automotive system, a mobile device, or another electronic device, among other examples. Additionally, or alternatively, the server may be equipped with a UFS interface to communicate with the memory system.

In some examples, the host system may perform one or more additional operations. For example, the host system may, based on the indication, determine that an adjustment to a trim setting of the memory system may improve a performance of the memory system. Additionally, or alternatively, the host system 105 may transmit a command to the memory system, and/or a population of similar memory systems, which implements the adjustment.

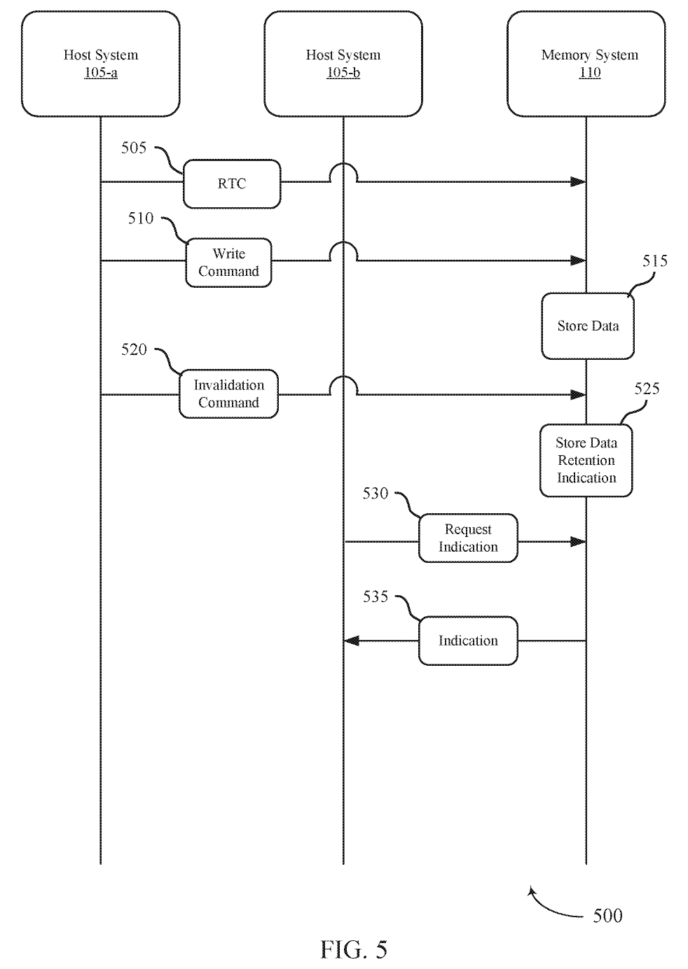

FIG. 5 shows an example of a transaction diagram 500 that supports data retention statistics of a memory system based on RTC information in accordance with examples as disclosed herein. The transaction diagram 500 includes signaling transactions between a host system 105-a (e.g., a first host system), a host system 105-b (e.g., a second host system that is separate from the first host system), and a memory system 110. In some examples, the host system 105-a and/or the host system 105-b may be remote from the memory system 110. In some examples, the memory system 110 of FIG. 5 may include one or more SSD devices. Additionally, or alternatively, and in some examples, signaling transactions between the host system 105-a, the host system 105-b, and the memory system 110 may use one or more of a serial advanced technology attachment (SATA) interface, a peripheral component interconnect express (PCIe) interface, and/or a non-volatile memory express (NVMe) interface, among other examples.

At signaling transaction 505, the host system 105-a may transmit RTC information to the memory system 110. In some examples, the host system 105-a may continuously transmit the RTC information to the memory system 110. In some other examples, the host system 105-a may periodically and/or intermittently transmit the RTC information to the memory system 110. In some other examples, the host system 105-a may transmit the RTC information to the memory system110 in response to receiving a request for the RTC information from the memory system 110.

At signaling transaction 510, the host system 105-a may transmit a write command to the memory system 110. The write command may include data that is to be stored by the memory system 110.

At operation 515, the memory system 110 may store the data. The memory system 110 may further store one or more entries in a data collection table (e.g., the data collection table 200 of FIG. 2), including a time at which the data was received and/or stored by the memory system 100 based on the RTC information.

At signaling transaction 520, the host system 105-a may transmit an invalidation command to the memory system 110 (e.g., a command causes the memory system 110 to invalidate the data). In some examples, the invalidation command may cause the memory system 110 to perform a garbage collection operation, a refresh operation, a write operation, a purge operation, an unmap operation, an erase operation, or another operation that invalidates the data,

At operation 525, the memory system 110 may store a data retention indication. The indication may be based, at least in part, on the time at which the memory system 110 received the write command (e.g., a first time associated with the signaling transaction 510) and a time at which the memory system 110 received the invalidation command (e.g., a second time associated with the signaling transaction 520). The indication may be determined and/or stored in a data collection table (e.g., the data collection table 200 of FIG. 2 and/or the data collection table 300 of FIG. 3), may include a raw data entry, a statistics entry, and/or an analytics entry as described in connection with FIG. 2 and/or FIG. 3. As examples, the indication may include one or more of a beginning storage address of the data, an ending storage address of the data, a time at which the data was initially stored (e.g., the first time associated with the signaling transaction 510), a time at which the invalidation command was received by the memory system 110 (e.g., the second time associated with the signaling transaction 520), a duration that the data was stored, a count for a time interval bin associated with the duration, and/or another suitable entry stored in the data collection table.

At signaling transaction 530, the host system 105-b may transmit a request for the indication to the memory system 110. In some examples, the request may specify a particular indication and/or combination of indications.

At signaling transaction 535, the memory system 110 may transmit the indication to the host system 105-b.

In some examples, the host system 105-a may be an embedded server that is integrated into an automotive system, a mobile device, or another electronic device, among other examples. Additionally, or alternatively, and in some examples, the host system 105-b may be an enterprise server used for high-speed data logging at a research and development center that supports design and development of the memory system 110, among other examples.

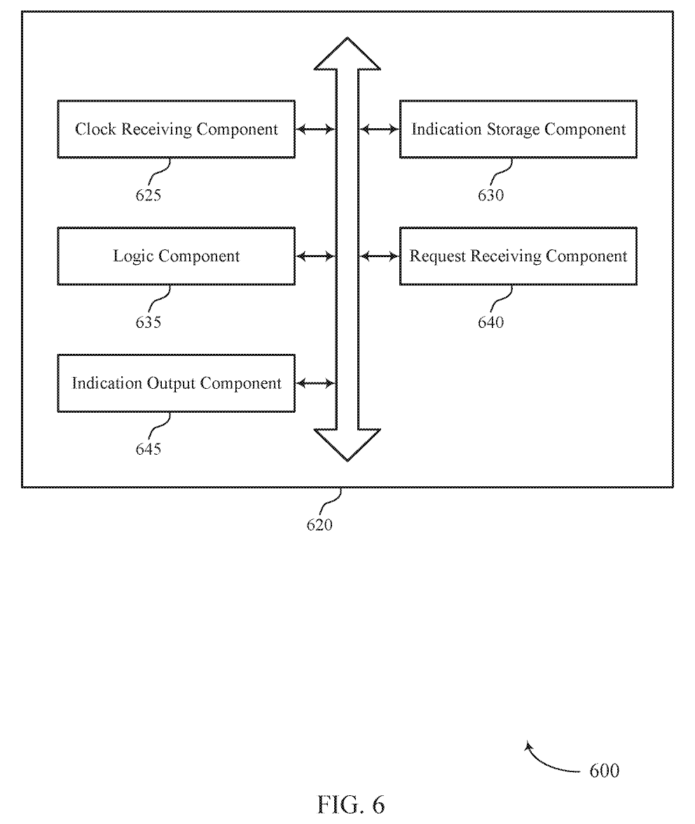

In some examples, the signaling transactions and operations described in connection with FIG. 5 may be parts of telemetry operations that monitor health, usage, and operational efficiencies of the memory system 110 and/or other similar memory systems. As described in greater detail in connection with FIGS. 5 and 6, the host system 105-a, the host system 105-b, and/or the memory system 110 may include different components (e.g., logic integrated circuitry) that may be configured to perform one or more aspects of the telemetry operations.

FIG. 6 shows a block diagram 600 of a memory system 620 that supports data retention statistics of a memory system based on RTC information in accordance with examples as disclosed herein. The memory system 620 may be an example of aspects of a memory system as described with reference to FIGS. 1 through 5. The memory system 620, or various components thereof, may be an example of means for performing various aspects of data retention statistics of a memory system based on RTC information as described herein. For example, the memory system 620 may include a clock receiving component 625, an indication storage component 630, a logic component 635, a request receiving component 640, an indication output component 645, or any combination thereof. Each of these components, or components of subcomponents thereof (e.g., one or more processors, one or more memories), may communicate, directly or indirectly, with one another (e.g., via one or more buses).

The clock receiving component 625 may be configured as or otherwise support a means for receiving RTC information from a host system. The indication storage component 630 may be configured as or otherwise support a means for storing data at the memory system at a first time, where the first time is associated with the RTC information. In some examples, the indication storage component 630 may be configured as or otherwise support a means for storing an indication associated with a duration that the data was stored at the memory system at a second time at which the data is invalidated, where the duration is associated with the RTC information.

In some examples, the logic component 635 may be configured as or otherwise support a means for performing an operation that invalidates the data at the second time, where the second time is associated with the RTC information. In some examples, the logic component 635 may be configured as or otherwise support a means for determining the duration based at least in part on the first time and the second time.

In some examples, to support performing the operation that invalidates the data at the second time, the logic component 635 may be configured as or otherwise support a means for performing a garbage collection operation. In some examples, to support performing the operation that invalidates the data at the second time, the logic component 635 may be configured as or otherwise support a means for performing a refresh operation. In some examples, to support performing the operation that invalidates the data at the second time, the logic component 635 may be configured as or otherwise support a means for performing a write operation. In some examples, to support performing the operation that invalidates the data at the second time, the logic component 635 may be configured as or otherwise support a means for a purge operation. In some examples, to support performing the operation that invalidates the data at the second time, the logic component 635 may be configured as or otherwise support a means for an unmap operation. In some examples, to support performing the operation that invalidates the data at the second time, the logic component 635 may be configured as or otherwise support a means for an erase operation.

In some examples, the logic component 635 may be configured as or otherwise support a means for incrementing a counter corresponding to a time interval bin associated with the duration.

In some examples, the request receiving component 640 may be configured as or otherwise support a means for receiving a request for the indication from a second host system. In some examples, the indication output component 645 may be configured as or otherwise support a means for outputting the indication to the second host system. In some examples, the first host system and the second host system are a same host system. In some examples, the first host system and the second host system are different host systems.

In some examples, to support receiving the request for the indication, the request receiving component 640 may be configured as or otherwise support a means for receiving a request for information that specifies the duration. In some examples, the indication specifies the duration.

In some examples, to support receiving the request, the request receiving component 640 may be configured as or otherwise support a means for receiving a request for a count of a time interval bin associated with the duration. In some examples, the indication specifies a count of a time interval bin associated with the duration.

In some examples, the described functionality of the memory system 620, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 620, or various components thereof, may be implemented at least in part by instructions (e.g., stored in memory, non-transitory computer-readable medium) executable by such at least one processor.

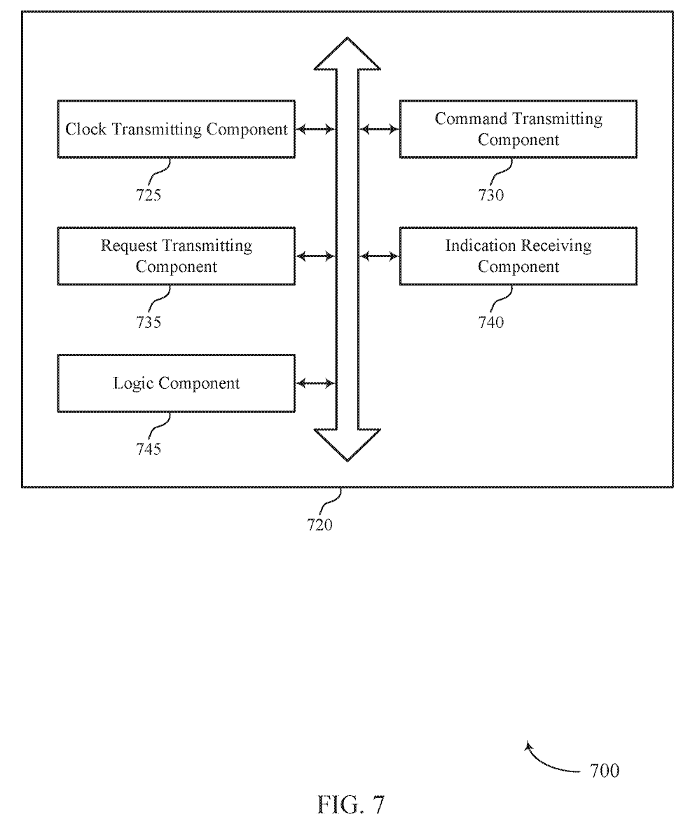

FIG. 7 shows a block diagram 700 of a host system 720 that supports data retention statistics of a memory system based on RTC information in accordance with examples as disclosed herein. The host system 720 may be an example of aspects of a host system as described with reference to FIGS. 1 through 5. The host system 720, or various components thereof, may be an example of means for performing various aspects of data retention statistics of a memory system based on RTC information as described herein. For example, the host system 720 may include a clock transmitting component 725, a command transmitting component 730, a request transmitting component 735, an indication receiving component 740, a logic component 745, or any combination thereof. Each of these components, or components of subcomponents thereof (e.g., one or more processors, one or more memories), may communicate, directly or indirectly, with one another (e.g., via one or more buses).

The clock transmitting component 725 may be configured as or otherwise support a means for transmitting, to a memory system, RTC information. The command transmitting component 730 may be configured as or otherwise support a means for transmitting, to the memory system, a command that causes invalidation of data stored in the memory system. The request transmitting component 735 may be configured as or otherwise support a means for transmitting, to the memory system, a request for an indication associated with a duration of storage of the data, where the indication is based at least in part on the RTC information and a time at which the command was received by the memory system. The indication receiving component 740 may be configured as or otherwise support a means for receiving, from the memory system, the indication.

In some examples, to support receiving the indication, the indication receiving component 740 may be configured as or otherwise support a means for receiving a beginning storage address of the data and an ending storage address of the data.

In some examples, to support receiving the indication, the indication receiving component 740 may be configured as or otherwise support a means for receiving a time at which the data was initially stored and the time at which the command was received by the memory system. In some examples, the indication specifies the duration. In some examples, the indication specifies a count for a time interval bin associated with the duration.

In some examples, the logic component 745 may be configured as or otherwise support a means for determining, based at least in part on the indication, a trim adjustment for the memory system. In some examples, the command transmitting component 730 may be configured as or otherwise support a means for transmitting, to the memory system, a second command that implements the trim adjustment.

In some examples, the described functionality of the host system 720, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the host system 720, or various components thereof, may be implemented at least in part by instructions (e.g., stored in memory, non-transitory computer-readable medium) executable by such at least one processor.

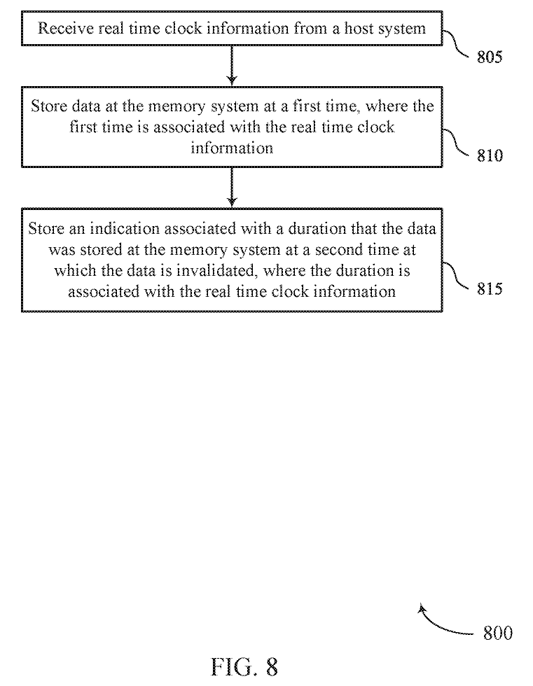

FIG. 8 shows a flowchart illustrating a method 800 that supports data retention statistics of a memory system based on RTC information in accordance with examples as disclosed herein. The operations of method 800 may be implemented by a memory system or its components as described herein. For example, the operations of method 800 may be performed by a memory system as described with reference to FIGS. 1 through 6. In some examples, a memory system may execute a set of instructions to control the functional elements of the device to perform the described functions. Additionally, or alternatively, the memory system may perform aspects of the described functions using special-purpose hardware.

At 805, the method may include receiving RTC information from a host system. In some examples, aspects of the operations of 805 may be performed by a clock receiving component 625 as described with reference to FIG. 6.

At 810, the method may include storing data at the memory system at a first time, where the first time is associated with the RTC information. In some examples, aspects of the operations of 810 may be performed by an indication storage component 630 as described with reference to FIG. 6.

At 815, the method may include storing an indication associated with a duration that the data was stored at the memory system at a second time at which the data is invalidated, where the duration is associated with the RTC information. In some examples, aspects of the operations of 815 may be performed by an indication storage component 630 as described with reference to FIG. 6.

In some examples, an apparatus as described herein may perform a method or methods, such as the method 800. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for receiving RTC information from a host system; storing data at the memory system at a first time, where the first time is associated with the RTC information; and storing an indication associated with a duration that the data was stored at the memory system at a second time at which the data is invalidated, where the duration is associated with the RTC information.

Aspect 2: The method, apparatus, or non-transitory computer-readable medium of aspect 1, further including operations, features, circuitry, logic, means, or instructions, or any combination thereof for performing an operation that invalidates the data at the second time, where the second time is associated with the RTC information and determining the duration based at least in part on the first time and the second time.

Aspect 3: The method, apparatus, or non-transitory computer-readable medium of aspect 2, where performing the operation that invalidates the data at the second time includes operations, features, circuitry, logic, means, or instructions, or any combination thereof for performing a garbage collection operation; performing a refresh operation; performing a write operation; a purge operation; an unmap operation; and an erase operation.

Aspect 4: The method, apparatus, or non-transitory computer-readable medium of any of aspects 1 through 3, further including operations, features, circuitry, logic, means, or instructions, or any combination thereof for incrementing a counter corresponding to a time interval bin associated with the duration.

Aspect 5: The method, apparatus, or non-transitory computer-readable medium of any of aspects 1 through 4, further including operations, features, circuitry, logic, means, or instructions, or any combination thereof for receiving a request for the indication from a second host system and outputting the indication to the second host system.

Aspect 6: The method, apparatus, or non-transitory computer-readable medium of aspect 5, where the first host system and the second host system are a same host system.

Aspect 7: The method, apparatus, or non-transitory computer-readable medium of any of aspects 5 through 6, where the first host system and the second host system are different host systems.

Aspect 8: The method, apparatus, or non-transitory computer-readable medium of any of aspects 5 through 7, where receiving the request for the indication includes operations, features, circuitry, logic, means, or instructions, or any combination thereof for receiving a request for information that specifies the duration.

Aspect 9: The method, apparatus, or non-transitory computer-readable medium of any of aspects 5 through 8, where the indication specifies the duration.

Aspect 10: The method, apparatus, or non-transitory computer-readable medium of any of aspects 5 through 9, where receiving the request includes operations, features, circuitry, logic, means, or instructions, or any combination thereof for receiving a request for a count of a time interval bin associated with the duration.

Aspect 11: The method, apparatus, or non-transitory computer-readable medium of any of aspects 5 through 10, where the indication specifies a count of a time interval bin associated with the duration.

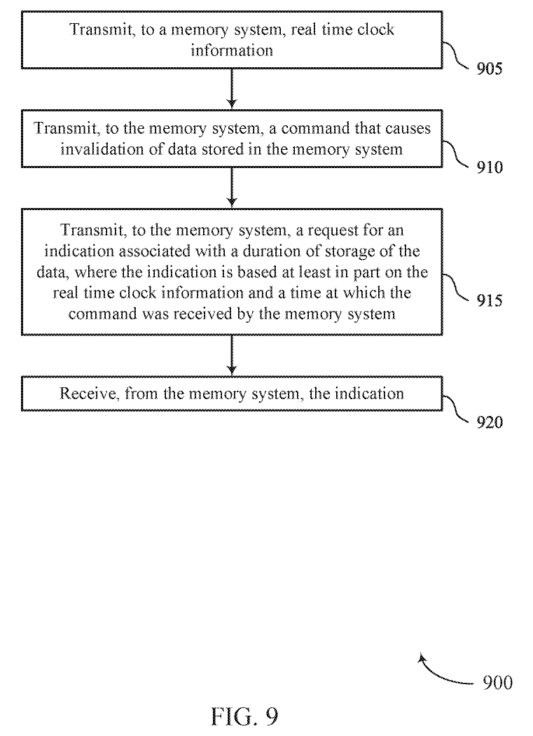

FIG. 9 shows a flowchart illustrating a method 900 that supports data retention statistics of a memory system based on RTC information in accordance with examples as disclosed herein. The operations of method 900 may be implemented by a host system or its components as described herein. For example, the operations of method 900 may be performed by a host system as described with reference to FIGS. 1 through 5 and 7. In some examples, a host system may execute a set of instructions to control the functional elements of the device to perform the described functions. Additionally, or alternatively, the host system may perform aspects of the described functions using special-purpose hardware.

At 905, the method may include transmitting, to a memory system, RTC information. In some examples, aspects of the operations of 905 may be performed by a clock transmitting component 725 as described with reference to FIG. 7.

At 910, the method may include transmitting, to the memory system, a command that causes invalidation of data stored in the memory system. In some examples, aspects of the operations of 910 may be performed by a command transmitting component 730 as described with reference to FIG. 7.

At 915, the method may include transmitting, to the memory system, a request for an indication associated with a duration of storage of the data, where the indication is based at least in part on the RTC information and a time at which the command was received by the memory system. In some examples, aspects of the operations of 915 may be performed by a request transmitting component 735 as described with reference to FIG. 7.

At 920, the method may include receiving, from the memory system, the indication. In some examples, aspects of the operations of 920 may be performed by an indication receiving component 740 as described with reference to FIG. 7.

In some examples, an apparatus as described herein may perform a method or methods, such as the method 900. The apparatus may include features, circuitry, logic, means, or instructions (e.g., a non-transitory computer-readable medium storing instructions executable by a processor), or any combination thereof for performing the following aspects of the present disclosure:

Aspect 12: A method, apparatus, or non-transitory computer-readable medium including operations, features, circuitry, logic, means, or instructions, or any combination thereof for transmitting, to a memory system, RTC information; transmitting, to the memory system, a command that causes invalidation of data stored in the memory system; transmitting, to the memory system, a request for an indication associated with a duration of storage of the data, where the indication is based at least in part on the RTC information and a time at which the command was received by the memory system; and receiving, from the memory system, the indication.

Aspect 13: The method, apparatus, or non-transitory computer-readable medium of aspect 12, where receiving the indication includes operations, features, circuitry, logic, means, or instructions, or any combination thereof for receiving a beginning storage address of the data and an ending storage address of the data.

Aspect 14: The method, apparatus, or non-transitory computer-readable medium of any of aspects 12 through 13, where receiving the indication includes operations, features, circuitry, logic, means, or instructions, or any combination thereof for receiving a time at which the data was initially stored and the time at which the command was received by the memory system.

Aspect 15: The method, apparatus, or non-transitory computer-readable medium of any of aspects 12 through 14, where the indication includes specifies the duration.

Aspect 16: The method, apparatus, or non-transitory computer-readable medium of any of aspects 12 through 15, where the indication specifies a count for a time interval bin associated with the duration.

Aspect 17: The method, apparatus, or non-transitory computer-readable medium of any of aspects 12 through 16, further including operations, features, circuitry, logic, means, or instructions, or any combination thereof for determining, based at least in part on the indication, a trim adjustment for the memory system and transmitting, to the memory system, a second command that implements the trim adjustment.

It should be noted that the described techniques include possible implementations, and that the operations and the steps may be rearranged or otherwise modified and that other implementations are possible. Further, portions from two or more of the methods may be combined.

An apparatus is described. The following provides an overview of aspects of the apparatus as described herein:

Aspect 18: A memory system, including: one or more memory devices; and processing circuitry coupled with the one or more memory devices and configured to cause the memory system to: receive RTC information; store data at a first time, where the first time is associated with the RTC information; invalidate data at a second time, where the second time is associated with the RTC information; and store, in a table, an indication that is associated with a duration that the data was stored, where the duration is based at least in part on the first time and the second time.

Aspect 19: The memory system of aspect 18, where the one or more memory devices are NAND memory devices that are part of a universal flash storage device.

Aspect 20: The memory system of any of aspects 18 through 19, where the one or more memory devices are NAND memory devices that are part of a solid-state drive storage device.

Aspect 21: The memory system of any of aspects 18 through 20, where the processing circuitry is further configured to cause the memory system to: perform a telemetry operation that provides the indication to a host system that is remote from the memory system.

Aspect 22: The memory system of any of aspects 18 through 21, where the processing circuitry is further configured to cause the memory system to: determine, based at least in part on the indication, a trimming parameter that improves a performance of the memory system; and implement the trimming parameter.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

As used herein, the term “substantially” means that the modified characteristic (e.g., a verb or adjective modified by the term substantially) need not be absolute but is close enough to achieve the advantages of the characteristic.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOS), or epitaxial layers of semiconductor materials on another substrate. The conductivity of the substrate, or sub-regions of the substrate, may be controlled through doping using various chemical species including, but not limited to, phosphorus, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor’s threshold voltage is applied to the transistor gate. The transistor may be “off” or “deactivated” if a voltage less than the transistor’s threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, instructions (e.g., code, software, firmware, logic) executed by a processing system (e.g., one or more processors, one or more controllers, control circuitry, processing circuitry, logic circuitry), or any combination thereof that is configured to cause a respective apparatus, device, or system to perform the described functions. If implemented as instructions executed by a processing system, the functions may be stored on or transmitted over as one or more instructions on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof, that are configured to cause the performance of the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, which can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or one or more processors.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method at a memory system, comprising:
receiving real time clock information from a host system;
storing data at the memory system at a first time, wherein the first time is associated with the real time clock information; and
storing an indication associated with a duration that the data was stored at the memory system at a second time at which the data is invalidated, wherein the duration is associated with the real time clock information.

2. The method of claim 1, further comprising:
performing an operation that invalidates the data at the second time, wherein the second time is associated with the real time clock information, and
determining the duration based at least in part on the first time and the second time.

3. The method of claim 2, wherein performing the operation that invalidates the data at the second time comprises:
performing a garbage collection operation;
performing a refresh operation;
performing a write operation;
a purge operation;
an unmap operation; or
an erase operation.

4. The method of claim 1, further comprising:
incrementing a counter corresponding to a time interval bin associated with the duration.

5. The method of claim 1, wherein the host system is a first host system and further comprising:
receiving a request for the indication from a second host system; and
outputting the indication to the second host system.

6. The method of claim 5, wherein the first host system and the second host system are a same host system.

7. The method of claim 5, wherein the first host system and the second host system are different host systems.

8. The method of claim 5, wherein receiving the request for the indication comprises:
receiving a request for information that specifies the duration.

9. The method of claim 5, wherein the indication specifies the duration.

10. The method of claim 5, wherein receiving the request comprises:
receiving a request for a count of a time interval bin associated with the duration.

11. The method of claim 5, wherein the indication specifies a count of a time interval bin associated with the duration.

12. A method at a host system, comprising:
transmitting, to a memory system, real time clock information;
transmitting, to the memory system, a command that causes invalidation of data stored in the memory system;
transmitting, to the memory system, a request for an indication associated with a duration of storage of the data, wherein the indication is based at least in part on the real time clock information and a time at which the command was received by the memory system; and
receiving, from the memory system, the indication.

13. The method of claim 12, wherein receiving the indication comprises:
receiving a beginning storage address of the data and an ending storage address of the data.

14. The method of claim 12, wherein receiving the indication comprises:
receiving a time at which the data was initially stored and the time at which the command was received by the memory system.

15. The method of claim 12, wherein the indication comprises specifies the duration.

16. The method of claim 12, wherein the indication specifies a count for a time interval bin associated with the duration.

17. A memory system, comprising:
one or more memory devices; and
processing circuitry coupled with the one or more memory devices and configured to cause the memory system to:
receive real time clock information;
store data at a first time, wherein the first time is associated with the real time clock information;
invalidate data at a second time, wherein the second time is associated with the real time clock information; and
store, in a table, an indication that is associated with a duration that the data was stored, wherein the duration is based at least in part on the first time and the second time.

18. The memory system of claim 17, wherein the one or more memory devices are NAND memory devices that are part of a universal flash storage device.

19. The memory system of claim 17, wherein the one or more memory devices are NAND memory devices that are part of a solid-state drive storage device.

20. The memory system of claim 17, wherein the processing circuitry is further configured to cause the memory system to:
perform a telemetry operation that provides the indication to a host system that is remote from the memory system.

21. The memory system of claim 17, wherein the processing circuitry is further configured to cause the memory system to:
determine, based at least in part on the indication, a trimming parameter that improves a performance of the memory system; and
implement the trimming parameter.
